(19) United States
(12) Patent Application Publication
(10) Pub. No.: US 2003/0053120 A1
(43) Pub. Date: Mar. 20, 2003

(54) Image transfer method, image server system, and program therefor

(75) Inventor: Wataru Ito, Kaisei-Machi (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/228,306

(22) Filed: Aug. 27, 2002

(30) Foreign Application Priority Data
Aug. 28, 2001 (JP) 257168/2001

(51) Int. Cl. B41J 1/00; B41F 1/00; G06F 15/00

(52) U.S. Cl. 358/1.15

(57) ABSTRACT

When an external terminal requests transfer of an image data set, the external terminal does not need to request a profile. The external terminal can reproduce an image corresponding to an output characteristic thereof, even if the terminal does not have a specific function such as processing of standardized image data. An image storing unit of an image server stores image data sets respectively having characteristics corresponding to output characteristics of external terminals including the external terminal. The external terminal sends transfer instruction information for requesting image data transfer. A judgment unit judges the output characteristic of the external terminal, based on the transfer instruction information. An image selection unit selects one of the image data sets having a characteristic corresponding to the output characteristic of the external terminal, based on a result of judgment. The selected image data set is sent to the external terminal.

### BACKGROUND OF THE INVENTION

1. Field of the Invention

The present invention relates to an image transfer method and an image server system for sending image data in response to a request from an external terminal. The present invention also relates to a program that causes a computer to execute the image transfer method.

2. Description of the Related Art

There have been provided network photograph services and network printing services. In a network photograph service, an image server is accessed via a network, and image data stored in the image server are displayed on a general-purpose monitor such as a CRT monitor or a liquid crystal display monitor or printed by a printer by downloading the image data via the network. A network printing service is specialized in providing a printing service via a network.

In such a network photograph service and a network printing service, an image reproduced by an external terminal accessing an image server has various characteristics. For example, if an image reproducing apparatus of an external terminal is a general-purpose monitor, the image reproduced by the apparatus has a frequency characteristic and a color reproduction characteristic specific to the general-purpose monitor. The characteristics of the reproduced image vary, depending on the type of the monitor such as a CRT and a liquid crystal display and a size thereof. If an image reproducing apparatus of an external terminal is a high-definition printer, an image reproduced by the printer has a frequency characteristic and a color reproduction characteristic specific to the high-definition printer. Therefore, since a characteristic of a reproduced image (hereinafter referred to as an output characteristic) varies depending on an external terminal, an image server needs to consider the output characteristic of the external terminal and to send image data having a characteristic corresponding to the output characteristic of the external terminal so that the reproduced image becomes appropriate for the external terminal. For this reason, a method of obtaining image data appropriate for an output characteristic of an external terminal has been proposed (Japanese Unexamined Patent Publication No. 10 (1998)-224643). In this method, a device profile corresponding to the type of an external terminal and a source profile representing a characteristic of image data are stored in an image server. An external terminal downloads image data, a source profile of the image data, and a device profile corresponding thereto. Color matching processing is carried out on the image data based on the profiles. In this manner, image data appropriate for an output characteristic of the external terminal can be obtained.

Furthermore, a method of converting image data has also been proposed (Japanese Patent No. 2660170). In this method, before image data read by a scanner are stored in an image server via a network, the scanner standardizes the image data so that the image data do not depend on a characteristic of an apparatus. When an external terminal reproduces the standardized image data, the image data are converted to become appropriate for an output characteristic of the external terminal. According to this method, since the image data stored in the image server have been standardized, conversion of the standardized image data in accordance with the output characteristic of the external terminal becomes easy. Consequently, the external terminal can reproduce an image appropriately.

However, in the method described in Japanese Unexamined Patent Publication No. 10(1998)-224643, the color matching processing cannot be carried out unless the external terminal requests the device profile and the source profile. Therefore, in the case where the external terminal does not request the profiles, the external terminal cannot reproduce the image data in accordance with the output characteristic thereof. Furthermore, in the method described in Japanese Patent No. 2660170, the external terminal needs to convert the standardized image data. Therefore, in the case where the external terminal does not have a function of processing the standardized image data, the external terminal cannot reproduce the image appropriately.

### SUMMARY OF THE INVENTION

The present invention has been conceived based on consideration of the above circumstances. An object of the present invention is therefore to provide an image transfer method, an image server system, and a program enabling reproduction of an image in accordance with an output characteristic of an external terminal, even in the case where the external terminal does not request profiles or the like and the external terminal does not have a specific function such as processing of standardized image data.

A first image transfer method of the present invention is a method of sending an image data set in response to a request from an external terminal, and the first image transfer method comprises the steps of:

receiving transfer instruction in formation regarding the image data set from the external terminal;

judging an output characteristic of the external terminal, based on the transfer instruction information;

selecting an image data set having a characteristic corresponding to the judged output characteristic from image data sets representing the same image respectively having different characteristics corresponding to output characteristics of various types of external terminals including the external terminal and stored in image storing means; and

sending the selected image data set to the external terminal.

The output characteristic of the external terminal represents a characteristic of an image reproduced by the external terminal. The output characteristic is determined based on a color space reproducible by the external terminal, a frequency characteristic of an image reproduced by the external terminal, a compression method appropriate for the external terminal such as a compression method not causing an artifact, and proper orientation of an image (portrait orientation or landscape orientation), for example.

The transfer instruction information refers to information necessarily sent from the external terminal to an image server when the external terminal requests transfer of image data from the image server. As the transfer instruction information, an output requesting protocol, the number of pixels necessary for image reproduction by the external terminal and/or the name of a service carried out by the external terminal can be used, for example.

As the output requesting protocol, a network protocol, an Internet http protocol, or a protocol via an i-mode (registered trade mark) server for mobile phones can be used, for example.

As the name of service, the name of a service for laboratories, a network service, or an i-mode service can be used, for example.

A second image transfer method of the present invention is a method of sending an image data set in response to a request from an external terminal, and the second image transfer method comprises the steps of:

receiving transfer instruction information regarding the image data set from the external terminal;

judging an output characteristic of the external terminal, based on the transfer instruction information;

generating an image data set having a characteristic corresponding to the judged output characteristic from the image data set that is stored in image storing means; and

sending the generated image data set to the external terminal.

A third image transfer method of the present invention is a method of sending an image data set in response to a request from an external terminal, and the third image transfer method comprises the steps of:

receiving transfer instruction information regarding the image data set from the external terminal;

judging an output characteristic of the external terminal, based on the transfer instruction information;

judging whether or not an image data set having a characteristic corresponding to the judged output characteristic is stored in image storing means for storing image data sets representing the same image respectively having different characteristics corresponding to output characteristics of various types of external terminals including the external terminal;

selecting the image data set having the characteristic corresponding to the judged output characteristic from the image data sets stored in the image storing means, in the case where the image data set having the characteristic corresponding to the judged output characteristic has been judged to be stored in the image storing means;

selecting an image data set having a characteristic close to the judged output characteristic from the image data sets stored in the image storing means and generating the image data set having the characteristic corresponding to the judged output characteristic from the selected image data set, in the case where the image data set having the characteristic corresponding to the judged output characteristic has been judged to be not stored in the image storing means; and

sending the selected image data set or the generated image data set to the external terminal.

A first image server system of the present invention is an image server system for sending an image data set in response to a request from an external terminal, and the first image server system comprises:

image storing means for storing image data sets representing the same image respectively having different characteristics corresponding to output characteristics of various types of external terminals including the external terminal;

reception means for receiving transfer instruction information regarding the image data set from the external terminal;

judgment means for judging an output characteristic of the external terminal, based on the transfer instruction information;

image selection means for selecting an image data set having a characteristic corresponding to the output characteristic judged by the judgment means from the image data sets stored in the image storing means; and

transfer means for sending the image data set selected by the image selection means to the external terminal.

A second image server system of the present invention is an image server system for sending an image data set in response to a request from an external terminal, and the second image server system comprises:

image storing means for storing the image data set;

reception means for receiving transfer instruction information regarding the image data set from the external terminal;

judgment means for judging an output characteristic of the external terminal, based on the transfer instruction information;

image generation means for generating an image data set having a characteristic corresponding to the output characteristic judged by the judgment means from the image data set stored in image storing means; and

transfer means for sending the image data set generated by the image generation means to the external terminal.

A third image server system of the present invention is an image server system for sending an image data set in response to a request from an external terminal, and the third image server system comprises:

image storing means for storing image data sets representing the same image respectively having different characteristics corresponding to output characteristics of various types of external terminals including the external terminal;

reception means for receiving transfer instruction information regarding the image data set from the external terminal;

judgment means for judging an output characteristic of the external terminal with reference to the transfer instruction information and for judging whether or not an image data set having a characteristic corresponding to the judged output characteristic is included in the image data sets stored in the image storing means;

image selection means for selecting the image data set having the characteristic corresponding to the judged output characteristic from the image data sets stored in the image storing means, in the case where the image data set having the characteristic corresponding to the judged output characteristic has been judged by the judgment means to be included in the image data sets stored in the image storing means;

image generation means for selecting an image data set having a characteristic close to the judged output characteristic from the image data sets stored in the image storing means and for generating the image data set having the characteristic corresponding to the judged output characteristic from the selected image data set, in the case where the image data set having the characteristic corresponding to the judged output characteristic has been judged by the judgment means to be not included in the image data sets stored in the image storing means; and

transfer means for sending the image data set selected by the image selection means or the image data set generated by the image generation means to the external terminal.

In the third image server system of the present invention, the judgment means may comprise means for judging the output characteristic of the external terminal with reference to the transfer instruction information, and means for judging whether or not the imaged at a set having the characteristic corresponding to the judged output characteristic is included in the image data sets stored in the image storing means.

Each of the image transfer methods of the present invention may be provided as a program causing a computer to execute the corresponding image transfer method.

According to the first image transfer method and the first image server system of the present invention, the output characteristic of the external terminal is judged based on the transfer instruction information when the external terminal requests image data transfer. The image data set having the characteristic corresponding to the judged output characteristic of the external terminal is selected from the image data sets stored in the image storing means and sent to the external terminal. Therefore, the external terminal can receive the image data set having the characteristic corresponding to the output characteristic thereof, without sending a specific request. Furthermore, even in the case where the external terminal does not have a specialized function, the external terminal can reproduce an image appropriately.

According to the second image transfer method and the second image server system of the present invention, the output characteristic of the external terminal is judged based on the transfer instruction information when the external terminal requests image data transfer. The image data set having the characteristic corresponding to the judged output characteristic of the external terminal is generated from the image data set stored in the image storing means and sent to the external terminal. Therefore, the external terminal can receive the image data set having the characteristic corresponding to the output characteristic thereof, without sending a specific request. Furthermore, even in the case where the external terminal does not have a specialized function, the external terminal can reproduce an image appropriately.

According to the third image transfer method and the third image server system of the present invention, the output characteristic of the external terminal is judged based on the transfer instruction information when the external terminal requests image data transfer. Whether or not the image data set having the characteristic corresponding to the judged output characteristic of the external terminal is stored in the image storing means is then judged. In the case where the image data set has been judged to be stored in the image storing means, the image data set is selected from the image data sets stored in the image storing means. In the case where the image data set having the characteristic corresponding to the judged output characteristic has been judged to be not stored in the image storing means, the image data set having the characteristic close to the judged output characteristic is selected from the image data sets stored in the image storing means and the image data set having the characteristic corresponding to the judged output characteristic is generated from the selected image data set. The selected image data set or the generated image data set is sent to the external terminal. Therefore, the external terminal can receive the image data set having the characteristic corresponding to the output characteristic thereof, without sending a specific request. Furthermore, even in the case where the external terminal does not have a specialized function, the external terminal can reproduce an image appropriately.

### BRIEF DESCRIPTION OF THE DRAWINGS

FIG. 1 is a block diagram showing a configuration of an image display system using an image server system of a first embodiment of the present invention;

FIG. 2 is a block diagram showing a configuration of an image server in the first embodiment;

FIG. 3 is a diagram showing visual characteristics for luminance and color difference at an observation distance of 30 cm;

FIG. 4 is a flow chart showing the operation of the first embodiment;

FIG. 5 is a block diagram showing a configuration of an image server in a second embodiment of the present invention;

FIG. 6 is a flow chart showing the operation of the second embodiment;

FIG. 7 is a block diagram showing a configuration of an image server in a third embodiment of the present invention; and

FIG. 8 is a flow chart showing the operation of the third embodiment.

### DESCRIPTION OF THE PREFERRED EMBODIMENTS

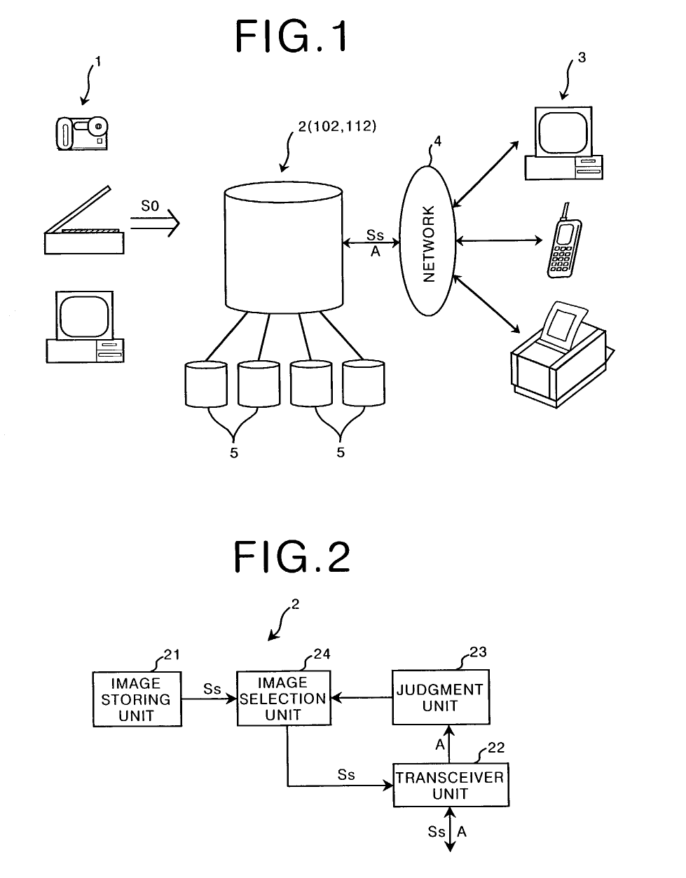

Hereinafter, embodiments of the present invention will be explained with reference to the accompanying drawings. FIG. 1 is a block diagram showing a configuration of an image display system using an image server system of a first embodiment of the present invention. As shown in FIG. 1, the image display system in the first embodiment comprises an image server 2 for storing a digital image data set S0 obtained by imaging means 1 such as a digital camera, a print scanner and a film scanner, a personal computer accessible to the image server 2 via a network 4, and an external terminal 3 such as laboratory equipment having a mobile phone and a high-definition printer. The image server 2 and other image servers 5 installed in other locations comprise one virtual server.

The external terminal 3 can download the image data set S0 by accessing the image server 2 via the network 4. In order to download the image data set S0, the external terminal 3 sends transfer instruction information A regarding the image data set S0 to the image server 2. The transfer instruction information A is information necessarily sent to the image server 2 when the external terminal 3 requests the image server 2 to send the image data set S0. The transfer instruction information A includes an output requesting protocol, the number of pixels necessary for reproducing an image by the external terminal 3 and/or the name of a service carried out by the external terminal 3, for example.

More specifically, in the case where the external terminal 3 is laboratory equipment, the output requesting protocol is a network protocol dedicated to laboratories. The number of pixels is the number of pixels of a high-definition printer or a monitor, depending on an apparatus used for image reproduction. The name of service is the name of a service for laboratories or a network printing service. In the case where the external terminal 3 is a personal computer, the output requesting protocol is an Internet http protocol and the number of pixels is the number of pixels of a monitor. In this case, no name of service is included in the transfer instruction information A, since a user himself/herself requests image data transfer. In the case where the external terminal 3 is a mobile phone, the output requesting protocol is a protocol via an i-mode server, for example. The number of pixels is the number of pixels of a liquid crystal display monitor of the mobile phone, and the name of service is the name of an i-mode service.

FIG. 2 is a block diagram showing a configuration of the image server 2 of the first embodiment of the present invention. As shown in FIG. 2, the image server 2 comprises an image storing unit 21 for storing image data sets S1 representing the same image and respectively having different characteristics corresponding to output characteristics of various types of external terminals including the external terminal 3, a transceiver unit 22 comprising a communication interface for receiving the transfer instruction information A sent via the network 4 and for sending an image data set Ss selected as will be explained later, a judgment unit 23 for judging an output characteristic of the external terminal 3 with reference to the transfer instruction information A received by the transceiver unit 22, and an image selection unit 24 for selecting the image data set Ss having the characteristic corresponding to the output characteristic of the external terminal 3 according to a result of judgment by the judgment unit 23 from the image data sets S1 stored in the image storing unit 21. In this embodiment, the transceiver unit 22 corresponds to reception means and transfer means. The image data sets S1 are generated by image generation means (not shown) based on the image data set S0 obtained by the imaging means 1, and stored in the image storing unit 21.

The output characteristic of the external terminal 3 represents a characteristic of an image reproduced by the external terminal 3. The output characteristic is determined based on a color space reproducible by the external terminal, a frequency characteristic of an image reproduced by the external terminal, a compression method appropriate for the external terminal 3 such as a compression method not causing an artifact, and proper orientation of an image (portrait orientation or landscape orientation), for example.

Hereinafter, the frequency characteristic will be explained below. Since a high-definition printer has a resolution different from a resolution of a CRT monitor, the size of one pixel is also different between them. For example, a 200-dpi resolution monitor has the pixel size three times larger than the pixel size of a 600-dpi resolution printer. For this reason, the size of an image reproduced by these apparatuses also varies. As a result, a visual characteristic also changes when the image reproduced by these apparatuses is viewed. Therefore, in the case where the transfer instruction information A is sent regarding the image data set S0 to the image server 2, the image data set to be sent to the external terminal 3 needs to have a frequency characteristic that is different between a high-definition printer and a monitor for appropriate reproduction, even if the number of pixels necessary for appropriate reproduction is the same between the printer and the monitor.

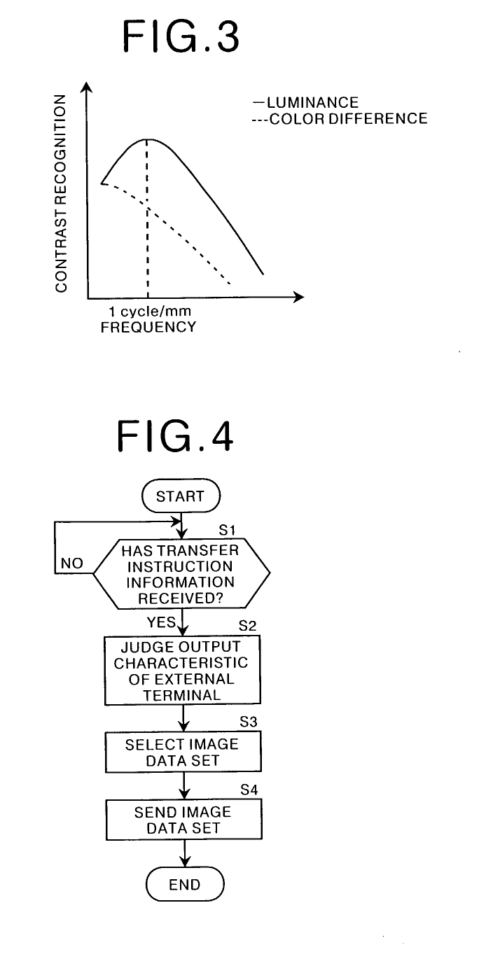

FIG. 3 is a diagram showing visual characteristics for luminance and color difference viewed at a distance of 30 cm. The horizontal axis represents frequency and the vertical axis represents contrast recognition, that is, a visual sensitivity. The solid line shows the characteristic for luminance and the broken line shows the characteristic for color difference. As shown by the solid line in FIG. 3, in the case of observation distance of 30 cm, a peak of the visual sensitivity comes around 1 cycle/mm. The visual sensitivity decreases in frequencies other than the peak value. Therefore, in the case of reproduction by a printer, it is preferable that a frequency band corresponding to 1 cycle/mm or higher is enhanced. On the contrary, in the case of reproduction by a monitor, information corresponding to 1 cycle/mm for a printer represents information corresponding to 0.33 cycle/mm for a monitor, if the pixel size is three times larger for the monitor than for the printer. Therefore, if an image data set having been subjected to image processing for reproduction by a printer is reproduced by a monitor, a signal corresponding to 1 cycle/mm that is originally considerably visible is enhanced too much, causing noise. Consequently, if the external terminal 3 uses a monitor for image reproduction, the image data set Ss having an enhanced frequency band different from the enhanced frequency band for a printer needs to be selected and sent to the external terminal 3.

Likewise, the same consideration is necessary for a compression rate. No artifact becomes conspicuous in an image reproduced by a printer if compression for cutting a frequency band of 1 cycle/mm or higher is carried out on the image. On the other hand, when the same compression is carried out on an image to be reproduced by a monitor, a frequency band wherein an artifact is generated exists in a range of high visual sensitivity. Therefore, the artifact becomes conspicuous. Consequently, in the case where the external terminal 3 uses a monitor for reproduction, the image data set Ss having a compressed frequency band different from a compressed frequency band for a printer needs to be selected and sent to the external terminal 3.

Meanwhile, regarding a color space, a color reproduction range (a dynamic range and a chromaticity range) varies between a printer and a monitor. Even among monitors, the color reproduction range varies, depending on the type of monitor, such as a CRT display, a TFT liquid crystal display, and an STN liquid crystal display. Therefore, even if the image data set Ss has information regarding a range outside the color reproduction range, the external terminal 3 cannot reproduce the information. Consequently, compression of the information regarding the irreproducible color range and mapping into a different color space become necessary in order to cause the information of irreproducible color range to be in a reproducible color range, depending on the type of the external terminal 3.

Furthermore, if an aspect ratio for the number of pixels included in the transfer instruction information A is different from an aspect ratio of the image represented by the image data set S0 obtained by the imaging means 1, trimming processing is carried out. The image represented by the image data set S0 may be an image to be reproduced in landscape orientation or an image in portrait orientation to be reproduced after rotation by 90 degrees. In the case where the image is reproduced by a printer or a liquid crystal display monitor of a mobile phone, a medium in which the image is reproduced can be rotated. Therefore, the orientation of the image does not cause a problem. However, in the case of trimming, it is preferable for a trimmed range to be as small as possible. Therefore, trimming needs to be carried out after rotation of the image by 90 degrees (that is, conversion from the landscape orientation to the portrait orientation, or vice versa) in the case of reproduction by a printer or a liquid crystal display monitor of a mobile phone, in order to cause the trimmed range to be smaller.

In this embodiment, the image data sets S1 respectively having different characteristics caused by various kinds of frequency processing, compression processing, color space conversion processing and/or rotation processing (including trimming processing) are generated from the image data set S0 and stored in the image storing unit 21, depending on the output characteristic of the external terminal 3. For example, in order to cause one of the image data sets S1 to have a characteristic appropriate for reproduction by a printer, the image data set S1 (hereinafter referred to as an image data set SP) has been subjected to frequency enhancement processing for causing a high frequency band around 2 cycles/mm that is higher than the 1 cycle/mm frequency to be enhanced more when reproduced by a printer and compression processing for compressing a frequency band of 3˜4 cycles/mm at a higher compression rate. The frequency band of 3˜4 cycles/mm is compressed at the higher compression rate because the frequency band cannot be recognized by human vision after reproduction. By this compression processing, the amount of information in the image data set SP can be reduced. Furthermore, the compression rate is set higher for a higher frequency for color difference, since the visual characteristic for color difference observed in the distance of 30 cm becomes lower in a higher frequency as shown by the broken line in FIG. 3. The trimming processing is carried out according to an aspect ratio that is often predetermined for a printer. The image is rotated by 90 degrees in order to cause the trimmed range to be as small as possible.

Meanwhile, in order to cause one of the image data sets S1 to have a characteristic appropriate for reproduction by a monitor, the image data set S1 (hereinafter referred to as an image data set SM) has been subjected to frequency enhancement processing for causing the high frequency band around 2 cycles/mm to be enhanced more when reproduced by a monitor. In this case, the compression rate is set lower in order to suppress an artifact, and a compression method suppressing an artifact can be adopted. In the compression method, the image data set is subjected to wavelet conversion and decomposed into frequency bands. When signals in the respective frequency bands are compressed, the compression rate is set lower for any of the frequency bands if an artifact could be easily generated therein. The trimming processing is also carried out according to an aspect ratio of a monitor, since the aspect ratio is predetermined. Since a monitor cannot be rotated, trimming processing is carried out without rotation regardless of whether the proper orientation of the image represented by the image data set SM is portrait orientation or landscape orientation.

For reproduction by a mobile phone, reduction processing has been carried out on one of the image data sets S1 (hereinafter referred to as an image data set SC) according to the size of a screen of a mobile phone, since the screen is considerably small. The image data set SC has not been subjected to frequency enhancement processing. Furthermore, since the reduction processing tends to cause colors to look darker, processing for enhancing color difference is carried out. Since an aspect ratio for reproduction by a mobile phone is often predetermined, trimming processing is carried out according to the predetermined aspect ratio. For the trimming processing, the image represented by the image data set SC is rotated by 90 degrees in order to cause a trimmed range to be as small as possible.

The judgment unit 23 judges the output characteristic of the external terminal 3 that sent the transfer instruction information A, based on the transfer instruction information A received by the transceiver unit 22. For example, if the output requesting protocol of the transfer instruction information A is a network protocol dedicated to laboratories and if the number of pixels is equal to or larger than a predetermined threshold value Th1, the output characteristic is judged to be an output characteristic for a high-definition printer. If the output requesting protocol of the transfer instruction information A is an Internet http protocol and if the number of pixels is less than the predetermined threshold value Th1, the output characteristic is judged to be an output characteristic for a monitor. If the output requesting protocol of the transfer instruction information A is a protocol via a server for i-mode and if the number of pixels is less than the predetermined threshold value Th1, the output characteristic is judged to be an output characteristic for a liquid crystal display monitor of a mobile phone.

In the case where the name of service in the transfer instruction information A represents a service for laboratories, the output characteristic is judged to be an output characteristic for a high-definition printer. If the name of service represents a network printing service and the number of pixels is equal to or larger than the predetermined threshold value Th1, the output characteristic is judged to be an output characteristic for a high-definition printer. If the name of service represents a network printing service and if the number of pixels is less than the predetermined threshold value Th1, the output characteristic is judged to be an output characteristic for a monitor. If the name of service represents an i-mode service, the output characteristic is judged to be an output characteristic for a liquid crystal display monitor of a mobile phone.

The judgment criteria adopted by the judgment unit 23 for judging the output characteristic of the external terminal 3 are not necessarily limited to those described above. For example, a range may be set for the number of pixels, and the protocol and the name of service may be divided into more categories. In this case, the image storing unit 21 stores the image data sets S1 having characteristics in accordance with the categories.

Meanwhile, if the judgment unit 23 cannot judge the output characteristic of the external terminal 3 with reference to the transfer instruction information A, the judgment result indicates a failure.

The image selection unit 24 selects the image data set Ss having the characteristic in accordance with the judgment result from the image data sets S1 stored in the image storing unit 21, based on the result of judgment by the judgment unit 23. The image selection unit 24 inputs the image data set Ss to the transceiver unit 22. The transceiver unit 22 then sends the selected image data set Ss to the external terminal 3 that sent the transfer instruction information A. In the case where the judgment result indicates the failure, the image selection unit 24 selects a standard image data set stored in the image storing unit 21 in advance.

The operation of the first embodiment will be explained next. FIG. 4 is a flow chart showing the operation of the first embodiment. The transceiver unit 22 judges whether or not the transfer instruction information A has been received (Step S1). If a result at Step S1 is affirmative, the transfer instruction information A is input to the judgment unit 23 and the judgment unit 23 judges the output characteristic of the external terminal 3 that sent the transfer instruction information A, based on the transfer instruction information A (Step S2). The image selection unit 24 selects the image data set Ss having the characteristic corresponding to the output characteristic of the external terminal 3 from the image data sets S1 stored in the image storing unit 21, based on the result of judgment by the judgment unit 23 (Step S3). The selected image data set Ss is then sent via the network 4 from the transceiver unit 22 to the external terminal 3 that sent the transfer instruction information A (Step S4), and the procedure ends.

As has been described above, in this embodiment, the external terminal 3 can receive the image data set Ss having the characteristic corresponding to the output characteristic thereof, without sending a special request therefor. Furthermore, even if the external terminal 3 does not have a specialized function for carrying out image processing on the image data set Ss, the external terminal 3 can reproduce the image appropriately.

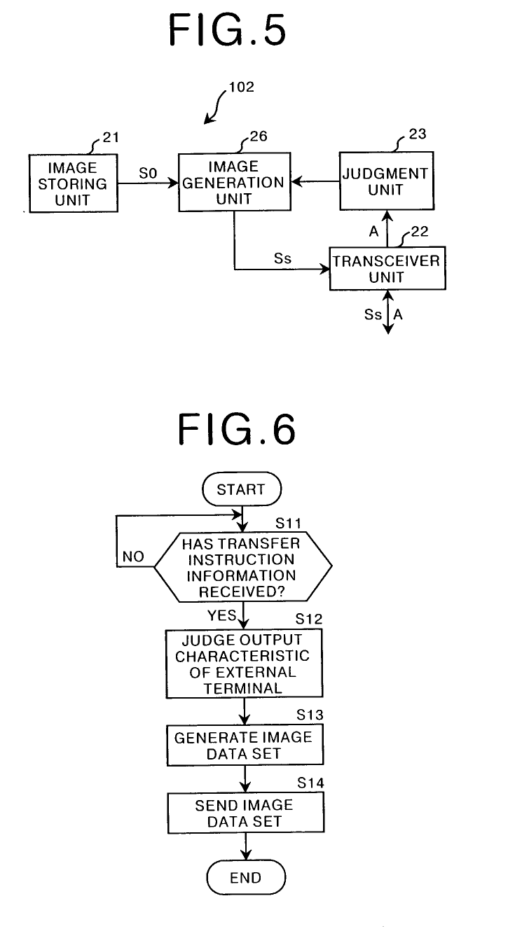

A second embodiment of the present invention will be explained next. In the second embodiment, elements other than an image server are the same as in the first embodiment. Therefore, detailed explanations thereof are omitted. FIG. 5 is a block diagram showing a configuration of an image server 102 in the second embodiment. As shown in FIG. 5, the image server 102 has an image generation unit 26 for generating an image data set Ss having a characteristic corresponding to an output characteristic of an external terminal 3 from an image data set S0 stored in an image storing unit 21 with reference to a result of judgment by a judgment unit 23, instead of the image selection unit 24 in the first embodiment. In the second embodiment, only the image data set S0 obtained by imaging means 1 is stored in the image storing unit 21, which is different from the first embodiment.

The image generation unit 26 carries out frequency processing, compression processing, color conversion processing, trimming processing, and/or rotation processing on the image data set S0, based on the result of judgment by the judgment unit 23. In this manner, the image data set Ss having the characteristic corresponding to the output characteristic of the external terminal 3 is generated. For example, in the case where the output characteristic of the external terminal 3 has been judged to be a characteristic for a high-definition printer, the image data set Ss having the same characteristic as the image data set SP for a high-definition printer in the first embodiment is generated from the image data set S0. In the case where the output characteristic of the external terminal 3 has been judged to be a characteristic for a monitor or for a liquid crystal display monitor of a mobile phone, the image data set Ss having the same characteristic as the image data set SM for a monitor or the image data set SC for a liquid crystal display monitor of a mobile phone in the first embodiment is generated from the image data set S0.

The operation of the second embodiment will be explained next. FIG. 6 is a flow chart showing the operation of the second embodiment. A transceiver unit 22 judges whether or not transfer instruction information A has been received (Step S11). If a result at Step S11 is affirmative, the transfer instruction information A is input to the judgment unit 23, and the judgment unit 23 judges the output characteristic of the external terminal 3 that sent the transfer instruction information A, based on the transfer instruction information A (Step S12). The image generation unit 26 generates the image data set Ss having the characteristic corresponding to the output characteristic of the external terminal 3 from the image data set S0 stored in the image storing unit 21, based on the result of judgment by the judgment unit 23 (Step S13). The generated image data set Ss is then sent via a network 4 from the transceiver unit 22 to the external terminal 3 that sent the transfer instruction information A (Step S14), and the procedure ends.

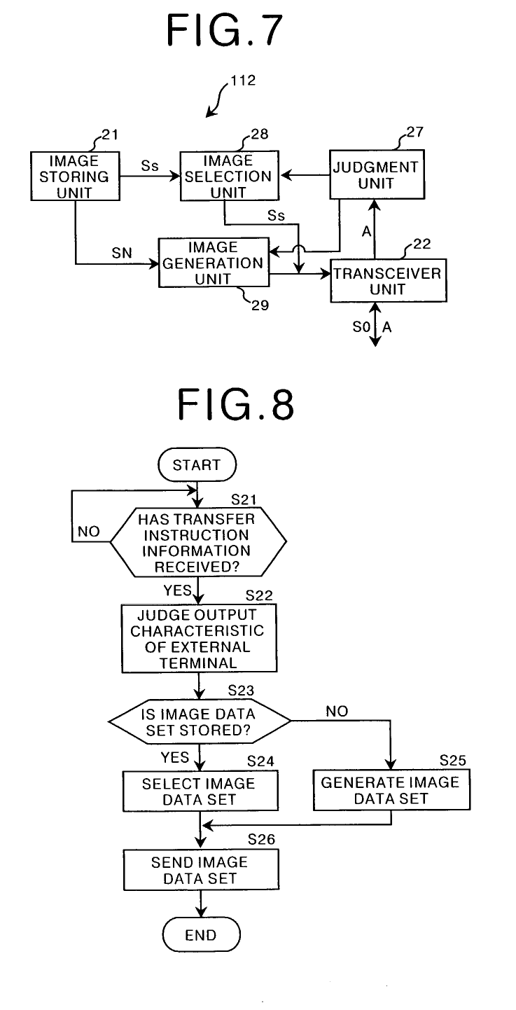

A third embodiment of the present invention will be explained next. In the third embodiment, elements other than an image server are the same as in the first embodiment. Therefore, detailed explanations thereof are not repeated. FIG. 7 is a block diagram showing a configuration of an image server 112 in the third embodiment. As shown in FIG. 7, the image server 112 comprises a judgment unit 27 for judging an output characteristic of an external terminal 3 that sent transfer instruction information A and for judging, based on a result of judgment of the output characteristic, whether or not an image data set Ss having a characteristic corresponding to the output characteristic of the external terminal 3 is included in image data sets S1 stored in an image storing unit 21, an image selection unit 28 for selecting like the image selection unit 24 in the first embodiment the image data set Ss having the characteristic corresponding to the output characteristic from the image data sets S1 stored in the image storing unit 21 in the case where the image data set Ss has been judged by the judgment unit 27 to be included in the image data sets S1 stored in the image storing unit 21, and an image generation unit 29 for selecting one of the image data sets S1 having a characteristic close to the output characteristic of the external terminal 3 (hereinafter referred to as an image data set SN) from the image data sets S stored in the image storing unit 21 and for generating the image data set Ss having the characteristic corresponding to the output characteristic of the external terminal 3 from the selected image data set SN in the case where the image data set Ss has been judged by the judgment unit 27 to be not included in the image data sets S1 stored in the image storing unit 21.

The image generation unit 29 carries out frequency processing, compression processing, color conversion processing, trimming processing, and/or rotation processing on the image data set SN, based on the result of judgment by the judgment unit 27. In this manner, the image data set Ss having the characteristic corresponding to the output characteristic of the external terminal 3 is generated. For example, in the case where the output characteristic of the external terminal 3 has been judged to be a characteristic for a high-definition printer, the image data set Ss having the same characteristic as the image data set SP for a high-definition printer in the first embodiment is generated from the selected image data set SN. In the case where the output characteristic of the external terminal 3 has been judged to be a characteristic for a monitor or for a liquid crystal display monitor of a mobile phone, the image data set Ss having the same characteristic as the image data set SM for a monitor or the image data set SC for a liquid crystal display monitor of a mobile phone in the first embodiment is generated from the selected image data set SN. Since the image data set SN to be processed has the characteristic close to the output characteristic of the external terminal 3, the amount of operation necessary for the image processing is less than the amount of image processing carried out by the image generation unit 26 in the second embodiment.

The operation of the third embodiment will be explained next. FIG. 8 is a flow chart showing the operation of the third embodiment. A transceiver unit 22 judges whether or not transfer instruction information A has been received (Step S21). If a result at Step S21 is affirmative, the transfer instruction information A is input to the judgment unit 27, and the judgment unit 27 judges the output characteristic of the external terminal 3 that sent the transfer instruction information A with reference to the transfer instruction information A (Step S22). At the same time, whether or not the image data set Ss having the characteristic corresponding to the output characteristic of the external terminal 3 is included in the image data sets S1 stored in the image storing unit 21 is also judged, based on the result of judgment regarding the output characteristic of the external terminal 3 (Step S23).

If a result at Step S23 is affirmative, the image selection unit 28 selects the image data set Ss having the characteristic corresponding to the output characteristic of the external terminal 3 from the image data sets S1 stored in the image storing unit 21, based on the result of judgment by the judgment unit 27 (Step S24). If the result at Step S23 is negative, the image generation unit 29 selects the image data set SN having the characteristic close to the output characteristic of the external terminal 3 from the image data sets S1 stored in the image storing unit 21, and generates the image data set Ss having the characteristic corresponding to the output characteristic of the external terminal 3 from the selected image data set SN, based on the result of judgment by the judgment unit 27 (Step S25). The image data set Ss selected by the image selection unit 28 or generated by the image generation unit 29 is then sent via a network 4 from the transceiver unit 22 to the external terminal 3 that sent the transfer instruction information A (Step S26), and the procedure ends.

A skilled artisan would know that computer readable media is not limited to any specific type of storage device and includes any kind of device, including but not limited to CDs, floppy discs, RAMs, ROMs, hard discs, magnetic tapes, and internet downloads, in which computer instructions can be stored and/or transmitted. Transmission of the computer code through a network or through wireless transmission means is also within the scope of this invention. Additionally, computer code/instructions include, but are not limited to, source, object, and executable code and can be in any language including higher level languages, assembly language and machine language.

What is claimed is:

1. An image transfer method for sending an image data set in response to a request from an external terminal, the image transfer method comprising the steps of:
receiving transfer instruction information regarding the image data set from the external terminal;
judging an output characteristic of the external terminal, based on the transfer instruction information;
selecting an image data set having a characteristic corresponding to the judged output characteristic from image data sets representing the same image respectively having different characteristics corresponding to output characteristics of various types of external terminals including the external terminal, the image data sets being stored in image storing means; and
sending the selected image data set to the external terminal.

2. An image transfer method for sending an image data set in response to a request from an external terminal, the image transfer method comprising the steps of:
receiving transfer instruction information regarding the image data set from the external terminal;
judging an output characteristic of the external terminal, based on the transfer instruction information;
generating an image data set having a characteristic corresponding to the judged output characteristic from the image data set that is stored in image storing means; and
sending the generated image data set to the external terminal.

3. An image transfer method for sending an image data set in response to a request from an external terminal, the image transfer method comprising the steps of:
receiving transfer instruction information regarding the image data set from the external terminal;
judging an output characteristic of the external terminal, based on the transfer instruction information;
judging whether or not an image data set having a characteristic corresponding to the judged output characteristic is stored in image storing means for storing image data sets representing the same image respectively having different characteristics corresponding to output characteristics of various types of external terminals including the external terminal;
selecting the image data set having the characteristic corresponding to the judged output characteristic from the image data sets stored in the image storing means, in the case where the image data set having the characteristic corresponding to the judged output characteristic has been judged to be stored in the image storing means;
selecting an image data set having a characteristic close to the judged output characteristic from the image data sets stored in the image storing means and generating the image data set having the characteristic corresponding to the judged output characteristic from the selected image data set, in the case where the image data set having the characteristic corresponding to the judged output characteristic has been judged to be not stored in the image storing means; and
sending the selected image data set or the generated image data set to the external terminal.

4. An image server system for sending an image data set in response to a request from an external terminal, the image server system comprising:
image storing means for storing image data sets representing the same image respectively having different characteristics corresponding to output characteristics of various types of external terminals including the external terminal;
reception means for receiving transfer instruction information regarding the image data set from the external terminal;
judgment means for judging an output characteristic of the external terminal, based on the transfer instruction information;
image selection means for selecting an image data set having a characteristic corresponding to the output characteristic judged by the judgment means from the image data sets stored in the image storing means; and
transfer means for sending the image data set selected by the image selection means to the external terminal.

5. An image server system for sending an image data set in response to a request from an external terminal, the image server system comprising:
image storing means for storing the image data set;
reception means for receiving transfer instruction information regarding the image data set from the external terminal;
judgment means for judging an output characteristic of the external terminal, based on the transfer instruction information;
image generation means for generating an image data set having a characteristic corresponding to the output characteristic judged by the judgment means from the image data set stored in image storing means; and
transfer means for sending the image data set generated by the image generation means to the external terminal.

6. An image server system for sending an image data set in response to a request from an external terminal, the image server system comprising:
image storing means for storing image data sets representing the same image respectively having different characteristics corresponding to output characteristics of various types of external terminals including the external terminal;
reception means for receiving transfer instruction information regarding the image data set from the external terminal;
judgment means for judging an output characteristic of the external terminal with reference to the transfer instruction information and for judging whether or not an image data set having a characteristic corresponding to the judged output characteristic is included in the image data sets stored in the image storing means;
image selection means for selecting the image data set having the characteristic corresponding to the judged output characteristic from the image data sets stored in the image storing means, in the case where the image data set having the characteristic corresponding to the judged output characteristic has been judged by the judgment means to be included in the image data sets stored in the image storing means;
image generation means for selecting an image data set having a characteristic close to the judged output characteristic from the image data sets stored in the image storing means and for generating the image data set having the characteristic corresponding to the judged output characteristic from the selected image data set, in the case where the image data set having the characteristic corresponding to the judged output characteristic has been judged by the judgment means to be not included in the image data sets stored in the image storing means; and
transfer means for sending the image data set selected by the image selection means or the image data set generated by the image generation means to the external terminal.

7. A program that causes a computer to execute an image transfer method for sending an image data set in response to a request from an external terminal, the program comprising the procedures of:
receiving transfer instruction information regarding the image data set from the external terminal;
judging an output characteristic of the external terminal, based on the transfer instruction information;
selecting an image data set having a characteristic corresponding to the judged output characteristic from image data sets representing the same image respectively having different characteristics corresponding to output characteristics of various types of external terminals including the external terminal, the image data sets being stored in image storing means; and
sending the selected image data set to the external terminal.

8. A program that causes a computer to execute an image transfer method for sending an image data set in response to a request from an external terminal, the program comprising the procedures of:
receiving transfer instruction information regarding the image data set from the external terminal;
judging an output characteristic of the external terminal, based on the transfer instruction information;
generating an image data set having a characteristic corresponding to the judged output characteristic from the image data set that is stored in image storing means; and
sending the generated image data set to the external terminal.

9. A program that causes a computer to execute an image transfer method for sending an image data set in response to a request from an external terminal, the program comprising the procedures of:
receiving transfer instruction information regarding the image data set from the external terminal;
judging an output characteristic of the external terminal, based on the transfer instruction information;
judging whether or not an image data set having a characteristic corresponding to the judged output characteristic is stored in image storing means for storing image data sets representing the same image respectively having different characteristics corresponding to output characteristics of various types of external terminals including the external terminal;
selecting the image data set having the characteristic corresponding to the judged output characteristic from the image data sets stored in the image storing means, in the case where the image data set having the characteristic corresponding to the judged output characteristic has been judged to be stored in the image storing means;
selecting an image data set having a characteristic close to the judged output characteristic from the image data sets stored in the image storing means and generating the image data set having the characteristic corresponding to the judged output characteristic from the selected image data set, in the case where the image data set having the characteristic corresponding to the judged output characteristic has been judged to be not stored in the image storing means; and
sending the selected image data set or the generated image data set to the external terminal.

10. A computer-readable recording medium storing a program that causes a computer to execute an image transfer method for sending an image data set in response to a request from an external terminal, the program comprising the procedures of:
receiving transfer instruction information regarding the image data set from the external terminal;
judging an output characteristic of the external terminal, based on the transfer instruction information;
selecting an image data set having a characteristic corresponding to the judged output characteristic from image data sets representing the same image respectively having different characteristics corresponding to output characteristics of various types of external terminals including the external terminal, the image data sets being stored in image storing means; and
sending the selected image data set to the external terminal.

11. A computer-readable recording medium storing a program that causes a computer to execute an image transfer method for sending an image data set in response to a request from an external terminal, the program comprising the procedures of:
receiving transfer instruction information regarding the image data set from the external terminal;
judging an output characteristic of the external terminal, based on the transfer instruction information;
generating an image data set having a characteristic corresponding to the judged output characteristic from the image data set that is stored in image storing means; and
sending the generated image data set to the external terminal.

12. A computer-readable recording medium storing a program that causes a computer to execute an image transfer method for sending an image data set in response to a request from an external terminal, the program comprising the procedures of:
receiving transfer instruction information regarding the image data set from the external terminal;
judging an output characteristic of the external terminal, based on the transfer instruction information;
judging whether or not an image data set having a characteristic corresponding to the judged output characteristic is stored in image storing means for storing image data sets representing the same image respectively having different characteristics corresponding to output characteristics of various types of external terminals including the external terminal;
selecting the image data set having the characteristic corresponding to the judged output characteristic from the image data sets stored in the image storing means, in the case where the image data set having the characteristic corresponding to the judged output characteristic has been judged to be stored in the image storing means;
selecting an image data set having a characteristic close to the judged output characteristic from the image data sets stored in the image storing means and generating the image data set having the characteristic corresponding to the judged output characteristic from the selected image data set, in the case where the image data set having the characteristic corresponding to the judged output characteristic has been judged to be not stored in the image storing means; and
sending the selected image data set or the generated image data set to the external terminal.
